(19) United States
(12) Patent Application Publication
(10) Pub. No.: US 2025/0024397 A1
(43) Pub. Date: Jan. 16, 2025

(54) SYSTEMS AND METHODS FOR ENHANCED POLICY PROPAGATION

(71) Applicant: Verizon Patent and Licensing Inc., Basking Ridge, NJ (US)

(72) Inventors: Lixia YAN, Basking Ridge, NJ (US); Violeta CAKULEV, Milburn, NJ (US); Ali Imdad MALIK, East Brunswick, NJ (US); Hossein M. AHMADI, Parsippany, NJ (US)

(73) Assignee: Verizon Patent and Licensing Inc., Basking Ridge, NJ (US)

(21) Appl. No.: 18/351,001

(22) Filed: Jul. 12, 2023

(51) Int. Cl. H04W 60/00; H04W 8/20

(52) U.S. Cl. CPC H04W 60/00; H04W 8/20

(57) ABSTRACT

In some implementations, a mobility management entity (MME) device may receive an attach request, associated with a user equipment (UE), that includes a UE state indication. The MME device may send, to an access and mobility function (AMF) device, a UE route selection policy (URSP) information request associated with the UE based on the UE state indication. The MME device may receive, from the AMF device, a URSP information response indicating URSP information associated with the UE based on the URSP information request. The MME may send, for the UE, the URSP information based on the UE state indication included in the attach request.

### BACKGROUND

In a wireless network, a policy control function (PCF) device provides policy information for a user equipment (UE). For example, the PCF device may provide a UE route selection policy (URSP) for the UE.

### BRIEF DESCRIPTION OF THE DRAWINGS

FIGS. 1A-1B are diagrams of an example associated with enhanced policy propagation.

FIG. 2A-B are diagrams of example environments in which systems and/or methods described herein may be implemented.

FIG. 3 is a diagram of example components of a device associated with enhanced policy propagation.

FIG. 4 is a flowchart of an example process associated with enhanced policy propagation.

FIG. 5 is a flowchart of an example process associated with enhanced policy propagation.

### DETAILED DESCRIPTION OF EXAMPLE EMBODIMENTS

The following detailed description of example implementations refers to the accompanying drawings. The same reference numbers in different drawings may identify the same or similar elements.

A user equipment (UE) may use policy information, such as information associated with a UE route selection policy (URSP), to perform one or more operations and/or procedures. The URSP information may include one or more traffic descriptors and/or one or more route selection descriptors, among other examples, that enable the UE to determine how to route outgoing traffic (e.g., to route the outgoing traffic over an appropriate network slice and/or to connect the outgoing traffic to appropriate protocol data unit (PDU) sessions, among other examples). For example, the UE may use the URSP to determine whether traffic associated with an application can be sent on an established protocol data unit (PDU) session, can be offloaded to non-3rd Generation Partnership Project (non-3GPP) access outside a PDU session, and/or can be used to trigger the establishment of a new PDU session, among other examples.

The URSP may include one or more URSP rules, and each URSP rule may include a UE policy section identifier (UPSI), a precedence value, traffic descriptors, and/or route selection descriptors. The traffic descriptors may be used to identify traffic associated with an application, such as a flow of traffic associated with the application. As an example, the traffic descriptors may include application descriptors (e.g., an operating system (OS) identifier (OSId) and/or an OS application identifier (OSAppId)), an internet protocol (IP) descriptor (e.g., an IP address, IPv6 network prefix, port number, protocol ID, security parameter index type, type of service, type of traffic class type, and/or a flow label type, among other examples), a domain descriptor (e.g., a destination fully qualified domain name (FQDN) and/or a regular expression as a domain name matching criteria), a non-IP descriptors, a data network name (DNN), and/or connection capabilities. The UE may use the traffic descriptors to identify an application and/or an application type, such as a streaming video application and/or a productivity application.

The one or more route selection descriptors may include information for establishing a data session for an application and/or for routing traffic associated with the application. As an example, the one or more route selection descriptors may include session and service continuity (SSC) mode information, network slice selection information (NSSI), data network (DN) information, PDU session type selection information, non-seamless offload indication information, access type preference information, location criteria type information, and/or time window type information.

Accordingly, the UE may use the URSP to route outgoing traffic over one or more network slices (e.g., the outgoing traffic may be routed over a network slice based on application and/or service requirements, among other examples). As an example, the UE may use the URSP to route outgoing traffic associated with a first application (e.g., executing on the UE) over a first network slice and may use the URSP to route traffic associated with a second application (e.g., executing on the UE) over a second network slice.

To provide the URSP for the UE, one or more network devices (e.g., associated with a wireless network) may interact with one another. As an example, a policy control function (PCF) device may send, and an access and mobility management function (AMF) device may receive, a URSP. The AMF device may forward (e.g., using non-access stratum (NAS) signaling) the URSP to the UE (e.g., via a base station), and the UE may use the URSP to route outgoing traffic.

In some cases, the PCF may generate an updated URSP. As an example, if a subscriber profile associated with the UE (e.g., stored in a unified data management (UDM) device and/or a unified data repository (UDR) device) is updated to indicate that traffic associated with an application (e.g., that executes on the UE) is to be routed over a low latency network slice, then the updated URSP (e.g., generated by the PCF device) may indicate that the traffic associated with the application is to be routed over the low latency network slice. The PCF device may send, and the AMF device may receive, the updated URSP. The AMF device may forward the updated URSP to the UE (e.g., via the base station).

However, in some cases, the PCF device may be unable to provide the URSP and/or the updated URSP for the UE because the UE has not previously communicated with the PCF device (e.g., the UE may not have established a connection with a network associated with the PCF device, among other examples). As a result, the UE is unable to appropriately control the outgoing traffic managed by the URSP (e.g., the UE cannot route the outgoing traffic over an appropriate network slice and/or cannot appropriately connect the outgoing traffic to appropriate protocol PDU sessions). This can lead to security vulnerabilities (e.g., the UE may route outgoing traffic over a low security network slice rather than a high security network slice) and/or can negatively affect QoS associated with UE and/or a user experience associated with the UE (e.g., the UE may route outgoing traffic over a normal network slice rather than a low latency network slice). Furthermore, if a 5G UE (e.g., a UE that supports 5G or New Radio (NR) coverage) is in a 4G coverage area, then the PCF device cannot propagate the URSP to the UE.

Some implementations described herein enable enhanced policy propagation (e.g., enhanced URSP propagation). For example, a mobility management entity (MME) device may receive an attach request (e.g., from a UE via a base station) that includes a UE state indication associated with the UE. In some implementations, receiving the attach request (e.g., from the base station) may trigger the MME device to select an AMF device, from a set of AMF devices, from which to retrieve URSP information associated with the UE, as described in more detail elsewhere herein.

The MME device may send, to an AMF device, a URSP information request (e.g., a request for URSP information) associated with the UE based on the UE state indication. The MME device may receive, from the AMF device, a URSP response (e.g., a URSP information response) indicating URSP information associated with the UE based on the URSP information request. The MME device may send, for the UE, the URSP information based on the UE state indication included in the attach request. The MME device may receive a manage UE policy complete message indicating that the UE has applied the URSP.

In this way, the PCF device can provide the URSP (e.g., including URSP information) and/or the updated URSP (e.g., including updated URSP information) based on the UE including the UE state indication in the attach request transmitted to the MME device (e.g., via the base station). As a result, the UE can appropriately control the outgoing traffic managed by the URSP and/or the updated URSP (e.g., based on the UE establishing a connection with the wireless network associated with the PCF device). This reduces security vulnerabilities and improves QoS associated with the UE and/or a user experience associated with the UE (e.g., because the UE can appropriately route the outgoing traffic based on the current URSP information).

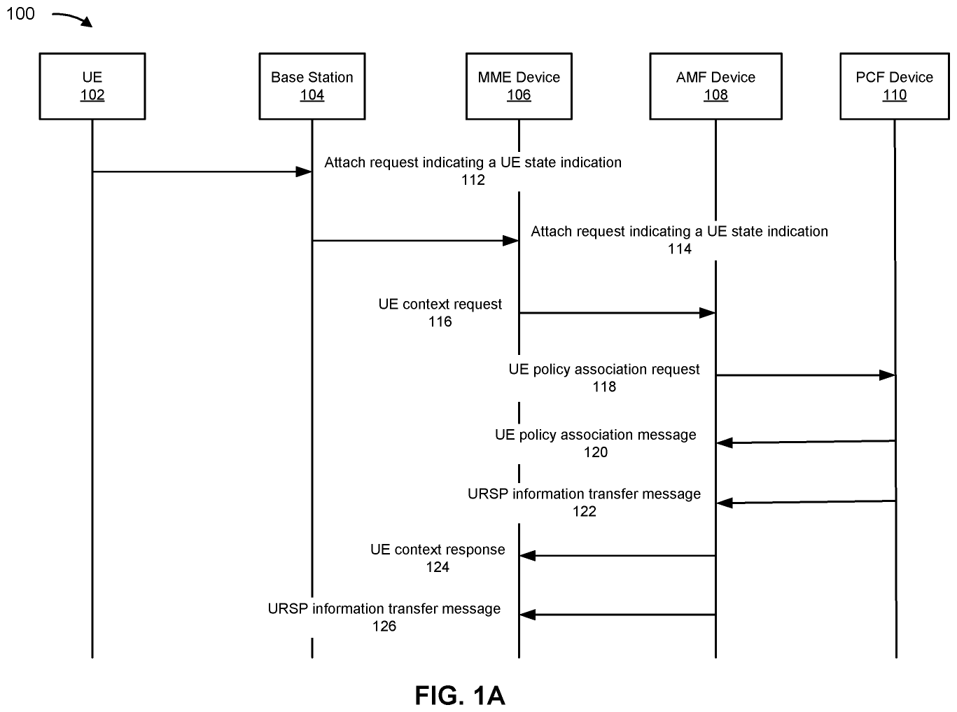

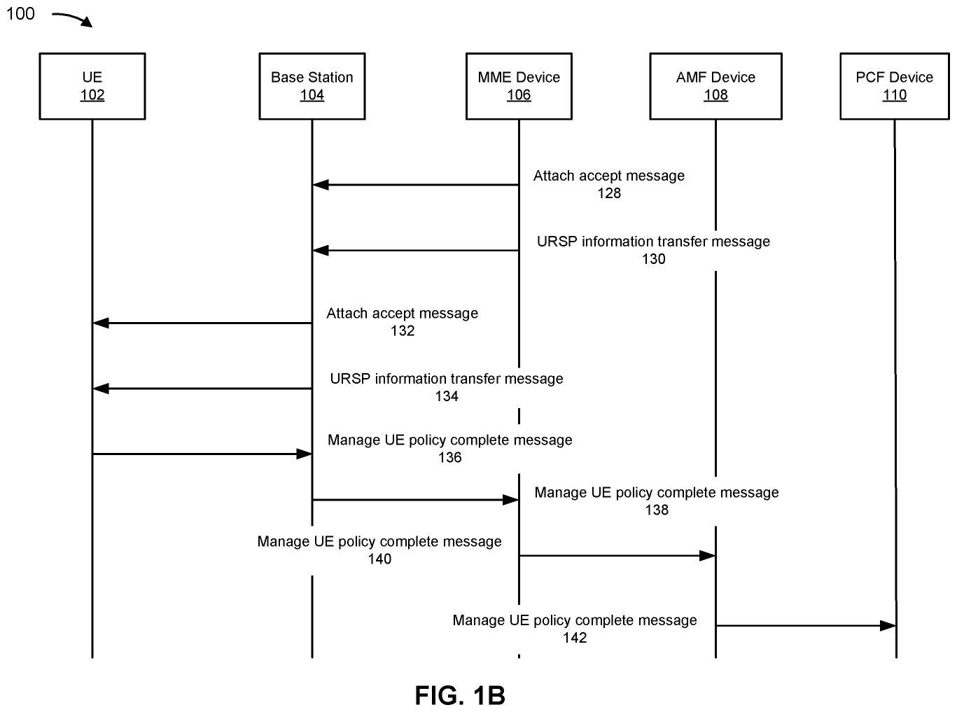

FIGS. 1A-1B are diagrams of an example 100 associated with enhanced policy propagation. As shown in FIGS. 1A-1B, example 100 includes a UE 102, a base station 104, an MME device 106, an AMF device, and a PCF device 110.

As shown in FIG. 1A, and by reference number 112, the UE 102 may transmit, and the base station 104 may receive, an attach request indicating a UE state indication. As an example, the UE 102 may transmit (e.g., to the base station 104) the attach request to register with a wireless network (e.g., associated with the base station 104 and/or the MME device 106).

In some implementations, the UE state indication may indicate an identifier of the UE (e.g., a globally unique temporary identifier (GUTI), among other examples), a procedure transaction identity (PTI), a UE state indication identity (e.g., associated with a UE delivery service message type), an UPSI, a UE policy classmark (e.g., that provides information associated with policies related to the UE 102), a UE OSId, URSP information (e.g., stored by the UE 102 and/or applied by the UE 102), and/or information indicating that the UE 102 supports applying URSP information to control outgoing traffic associated with the UE 102, among other examples.

As further shown in FIG. 1A, and by reference number 114, the base station 104 may send, and the MME device 106 may receive, the attach request indicating the UE state indication. For example, the base station 104 may forward the attach request, indicating the UE state indication, to the MME device 106 based on receiving the attach request indicating the UE state indication from the UE 102.

In some implementations, receiving the attach request (e.g., from the base station 104) may trigger the MME device 106 to select an AMF device (e.g., the AMF device 108) from which to retrieve URSP information associated with the UE. As an example, the MME device 106 may select the AMF device 108 (e.g., from which to retrieve the URSP information) based on the GUTI associated with the UE 102 (e.g., which may be stored by the AMF device 108 based on previous interactions associated with the UE 102).

As another example, the MME device 106 may select the AMF device 108 (e.g., from which to retrieve the URSP information) based on a distance between a location of the MME device 106 and a location of the AMF device 108 (e.g., the MME device 106 may select the AMF device 108, from a set of AMF devices, based on AMF device 108 being located closest in proximity to the MME device 106 than other AMF devices, from the set of AMF devices). For example, in some implementations, the AMF device 108 may select the AMF device 108 based on the distance between the location of the MME device 106 and the location of the AMF device 108 in cases where the GUTI associated with the UE 102 is unavailable.

As further shown in FIG. 1A, and by reference number 116, the MME device 106 may send, and the AMF device 108 may receive, a UE context request. As an example, the MME device 106 may send, and the AMF device 108 may receive, the UE context request based on selecting the AMF device 108 from which to retrieve the URSP information. Accordingly, for example, the UE context request may indicate a request to retrieve the URSP information associated with the UE 102, as described in more detail elsewhere herein.

As further shown in FIG. 1A, and by reference number 118, the AMF device 108 may send, and the PCF device 110 may receive, a UE policy association request. For example, the AMF device 108 may send, and the PCF device 110 may receive, the UE policy association request based on the UE context request. In some implementations, the UE policy association request may indicate the request to retrieve the URSP information associated with the UE 102.

As further shown in FIG. 1A, and by reference number 120, the PCF device 110 may send, and the AMF device 108 may receive, a UE policy association message. For example, the PCF device 110 may send, and the AMF device 108 may receive, the UE policy association message in response to creating a URSP associated with the UE 102. As an example, the PCF device 110 may retrieve the URSP information associated with the UE 102 from a subscriber profile (e.g., stored in a UDM device and/or a UDR device) associated with the UE 102. The PCF device 110 may create the URSP based on the URSP information associated with the UE 102 (e.g., the PCF device 110 may determine one or more policies to be applied to the UE 102 based on the URSP information associated with the UE 102). The UE policy association message (e.g., provided by the PCF 110 device to the AMF device 108) may indicate the URSP and/or information included in the URSP.

As further shown in FIG. 1A, and by reference number 122, the PCF device 110 may send, and the AMF device 108 may receive, a URSP information transfer message. For example, the PCF device 110 may send, and the AMF device 108 may receive, the URSP information transfer message indicating the URSP information based on the UE state indication. In this way, although the UE 102 is not connected to the wireless network associated with the PCF device 110 (e.g., a 5G or NR network), the UE 102 can receive the URSP information. Although the UE policy message (e.g., described in connection with FIG. 1A and reference number 120) and the URSP information transfer message (e.g., described in connection with FIG. 1A and reference number 122) are described as being provided by the PCF device 110 to the AMF device 108 via two separate communications, the UE policy association message and the URSP information transfer message may be sent by the PCF device 110, and received by the AMF device 108, via a single communication.

As further shown in FIG. 1A, and by reference number 124, the AMF device 108 may send, and the MME device 106 may receive, a UE context response. For example, the AMF device 108 may send, and the MME device 106 may receive, the UE context response in response to receiving the UE policy association message (e.g., from the PCF device 110). In some implementations, the UE context response may indicate the UE context associated with the UE 102.

As further shown in FIG. 1A, and by reference number 126, the AMF device 108 device may send, and the MME device 106 may receive, the URSP information transfer message. For example, the AMF device 108 may forward the URSP information transfer message to the MME device 106 based on receiving the URSP information transfer message from the PCF device 110. Although the UE policy message (e.g., described in connection with FIG. 1A and reference number 124) and the URSP information transfer message (e.g., described in connection with FIG. 1A and reference number 126) are described as being forwarded by the AMF device 108 to the MME device 106 via two separate communications, the UE policy association message and the URSP information transfer message may be forwarded by the AMF device 108, and received by the MME device 106, via a single communication.

As shown in FIG. 1B, and by reference number 128, the MME device 106 may send, and the base station 104 may receive, an attach accept message. For example, the MME device 106 may send, and the base station 104 may receive, the attach accept message based on receiving the UE context response from the AMF device 108. The attach accept message may indicate that the UE 102 has been registered with network associated with the PCF device 110.

As further shown in FIG. 1B, and by reference number 130, the MME device 106 may send, and the base station 104 may receive, the URSP information transfer message. For example, the MME device 106 may forward the URSP information transfer message to the base station 104 based on receiving the URSP information transfer message from the AMF device 108. Although the attach accept message (e.g., described in connection with FIG. 1B and reference number 128) and the URSP information transfer message (e.g., described in connection with FIG. 1B and reference number 130) are described as being forwarded by the MME device 106 to the base station 104 via two separate communications, the attach accept message and the URSP information transfer message may be forwarded by the AMF device 108 and received by the MME device 106 via a single communication.

As further shown in FIG. 1B, and by reference number 132, the base station 104 may transmit, and the UE 102 may receive, the attach accept message. For example, the base station 104 may forward the attach accept message to the UE 102 based on receiving the attach accept message from the MME device 106.

As further shown in FIG. 1B, and by reference number 134, the base station 104 may transmit, and the UE 102 may receive, the URSP information transfer message. For example, the base station 104 may forward the URSP information transfer message to the UE 102 based on receiving the URSP information transfer message from the MME device 106. Although the attach accept message (e.g., described in connection with FIG. 1B and reference number 132) and the URSP information transfer message (e.g., described in connection with FIG. 1B and reference number 134) are described as being forwarded by the base station 104 to the UE 102 via two separate communications, the attach accept message and the URSP information transfer message may be forwarded by the base station 104 and received by the UE 102 via a single communication.

As further shown in FIG. 1B, and by reference number 136, the UE 102 may transmit, and the base station 104 may receive, a manage UE policy complete message. For example, the UE 102 may transmit, and the base station 104 may receive, the manage UE policy complete message based on the UE 102 applying the URSP information (e.g., included in the URSP information transfer message). The manage UE policy complete message may indicate that the UE 102 has applied the URSP information.

As further shown in FIG. 1B, and by reference number 138, the base station 104 may send, and the MME device 106 may receive, the manage UE policy complete message. For example, the base station 104 may forward the UE policy complete message to the MME device 106 based on receiving the UE policy complete message from the UE 102.

As further shown in FIG. 1B, and by reference number 140, the MME device 106 may send, and the AMF device 108 may receive, the manage UE policy complete message. For example, the MME device 106 may forward the UE policy complete message to the AMF device 108 based on receiving the UE policy complete message from the base station 104.

As further shown in FIG. 1B, and by reference number 142, the AMF device 108 may send, and the PCF device 110 may receive, the manage UE policy complete message. For example, the AMF device 108 may forward the UE policy complete message to the PCF device 110 based on receiving the UE policy complete message from the MME device 106.

In this way, the PCF device 110 can provide the URSP (e.g., including URSP information) and/or the updated URSP (e.g., including updated URSP information) based on the UE 102 including the UE state indication in the attach request transmitted to the MME device 106 (e.g., via the base station 104). As a result, the UE 102 can appropriately control the outgoing traffic managed by the URSP and/or the updated URSP (e.g., based on the UE 102 establishing a connection with the wireless network associated with the PCF device 110). This reduces security vulnerabilities and improves QoS associated with the UE and/or a user experience associated with the UE (e.g., because the UE can appropriately route the outgoing traffic).

As indicated above, FIGS. 1A-1B are provided as an example. Other examples may differ from what is described with regard to FIGS. 1A-1B. The number and arrangement of devices shown in FIGS. 1A-1B are provided as an example. In practice, there may be additional devices, fewer devices, different devices, or differently arranged devices than those shown in FIGS. 1A-1B. Furthermore, two or more devices shown in FIGS. 1A-1B may be implemented within a single device, or a single device shown in FIGS. 1A-1B may be implemented as multiple, distributed devices. Additionally, or alternatively, a set of devices (e.g., one or more devices) shown in FIGS. 1A-1B may perform one or more functions described as being performed by another set of devices shown in FIGS. 1A-1B.

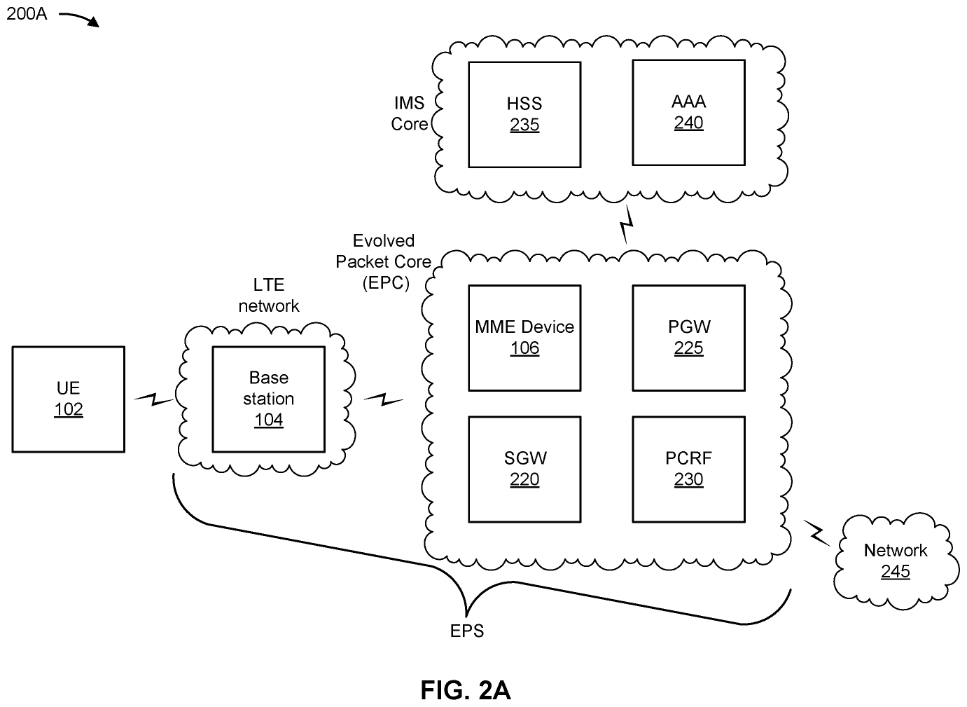

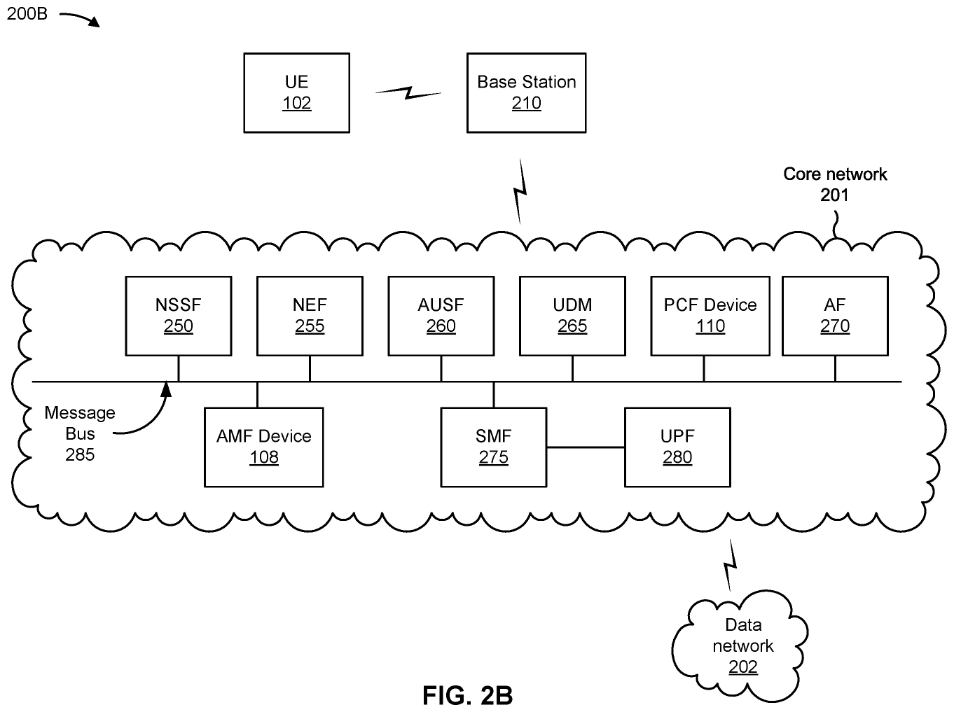

FIG. 2A is a diagram of an example environment 200A in which systems and/or methods described herein may be implemented. As shown in FIG. 2A, environment 200A may include a UE 102, a base station 104, an MME device 106, a serving gateway (SGW) 220, a packet data network gateway (PGW) 225, a policy and charging rules function (PCRF) 230, a home subscriber server (HSS) 235, an authentication, authorization, and accounting server (AAA) 240, and a network 245. Devices of environment 200A may interconnect via wired connections, wireless connections, or a combination of wired and wireless connections.

Some implementations are described herein as being performed within a long-term evolution (LTE) network for explanatory purposes. Some implementations may be performed within a network that is not an LTE network, such as a third generation (3G) network or a fifth generation (5G) network.

Environment 200A may include an evolved packet system (EPS) that includes an LTE network and/or an evolved packet core (EPC) that operate based on a third-generation partnership project (3GPP) wireless communication standard. The LTE network may include a radio access network (RAN) that includes one or more base stations 104 that may take the form of evolved Node Bs (eNBs) via which UE 102 communicates with the EPC. The EPC may include the MME device 106, SGW 220, and/or PGW 225 to enable UE 102 to communicate with network 245 and/or an Internet protocol (IP) multimedia subsystem (IMS) core. The IMS core may include HSS 235 and/or AAA 240, and may manage device registration and authentication, session initiation, and/or other operations associated with user devices 205. HSS 235 and/or AAA 240 may reside in the EPC and/or the IMS core.

UE 102 includes one or more devices capable of communicating with other user devices, base station 104, and/or a network (e.g., network 245). For example, UE 102 may include a mobile phone (e.g., a smart phone, a radiotelephone, etc.), a laptop computer, a tablet computer, a desktop computer, a handheld computer, a gaming device, a wearable communication device (e.g., a smart wristwatch, a pair of smart eyeglasses, etc.), or a similar type of device. UE 102 may send traffic to and/or receive traffic from another UE 102 and/or network 245 (e.g., via base station 104, SGW 220, and/or PGW 225).

Base station 104 includes one or more devices capable of transferring traffic, such as audio, video, text, and/or other traffic, destined for and/or received from UE 102. In some implementations, base station 104 may include an eNB associated with the LTE network that receives traffic from and/or sends traffic to network 245 via SGW 220 and/or PGW 225. Additionally, or alternatively, one or more base stations 104 may be associated with a RAN that is not associated with the LTE network. Base station 104 may send traffic to and/or receive traffic from UE 102 via an air interface. In some implementations, base station 104 may include a small cell base station, such as a base station of a microcell, a picocell, or a femtocell.

The MME device 106 includes one or more devices, such as one or more server devices, capable of managing authentication, activation, deactivation, and/or mobility functions associated with UE 102. In some implementations, the MME device 106 may perform operations relating to authentication of UE 102. Additionally, or alternatively, the MME device 106 may facilitate the selection of a particular SGW 220 and/or a particular PGW 225 to provide traffic to and/or from UE 102. The MME device 106 may perform operations associated with handing off UE 102 from a first base station 104 to a second base station 104 when UE 102 is transitioning from a first cell associated with the first base station 104 to a second cell associated with the second base station 104. Additionally, or alternatively, the MME device 106 may select another MME (not shown in FIG. 2A), to which UE 102 should be handed off (e.g., when UE 102 moves out of range of the MME device 106).

SGW 220 includes one or more devices capable of routing packets. For example, SGW 220 may include one or more data processing and/or traffic transfer devices, such as a gateway, a router, a modem, a switch, a firewall, a network interface card (NIC), a hub, a bridge, a server device, an optical add/drop multiplexer (OADM), or any other type of device that processes and/or transfers traffic. In some implementations, SGW 220 may aggregate traffic received from one or more base stations 104 associated with the LTE network, and may send the aggregated traffic to network 245 (e.g., via PGW 225) and/or other network devices associated with the EPC and/or the IMS core. SGW 220 may receive traffic from network 245 and/or other network devices, and may send the received traffic to UE 102 via base station 104. Additionally, or alternatively, SGW 220 may perform operations associated with handing off UE 102 to and/or from an LTE network.

PGW 225 includes one or more devices capable of providing connectivity for UE 102 to external packet data networks (e.g., other than the depicted EPC and/or LTE network). For example, PGW 225 may include one or more data processing and/or traffic transfer devices, such as a gateway, a router, a modem, a switch, a firewall, a NIC, a hub, a bridge, a server device, an OADM, or any other type of device that processes and/or transfers traffic. In some implementations, PGW 225 may aggregate traffic received from one or more SGWs 220, and may send the aggregated traffic to network 245. Additionally, or alternatively, PGW 225 may receive traffic from network 245, and may send the traffic to UE 102 via SGW 220 and base station 104. PGW 225 may record data usage information (e.g., byte usage), and may provide the data usage information to AAA 240.

PCRF 230 includes one or more devices, such as one or more server devices, capable of providing policy control decision and flow-based charging control functionalities. For example, PCRF 230 may provide network control regarding service data flow detection, gating, and/or quality of service (QoS) and flow-based charging, among other examples. In some implementations, PCRF 230 may determine how a certain service data flow is to be treated, and may ensure that user plane traffic mapping and treatment is in accordance with a user subscription profile.

HSS 235 includes one or more devices, such as one or more server devices, capable of managing (e.g., receiving, generating, storing, processing, and/or providing) information associated with UE 102. For example, HSS 235 may manage subscription information associated with UE 102, such as information that identifies a subscriber profile of a user associated with UE 102, information that identifies services and/or applications that are accessible to UE 102, location information associated with UE 102, a network identifier (e.g., a network address) that identifies UE 102, information that identifies a treatment of UE 102 (e.g., quality of service information, a quantity of minutes allowed per time period, and/or a quantity of data consumption allowed per time period), and/or similar information. HSS 235 may provide this information to one or more other devices of environment 200A to support the operations performed by those devices.

AAA 240 includes one or more devices, such as one or more server devices, that perform authentication, authorization, and/or accounting operations for communication sessions associated with UE 102. For example, AAA 240 may perform authentication operations for UE 102 and/or a user of UE 102 (e.g., using one or more credentials), may control access, by UE 102, to a service and/or an application (e.g., based on one or more restrictions, such as time-of-day restrictions, location restrictions, single or multiple access restrictions, read/write restrictions, etc.), may track resources consumed by UE 102 (e.g., a quantity of voice minutes consumed and/or a quantity of data consumed, among other examples), and/or may perform similar operations.

Network 245 includes one or more wired and/or wireless networks. For example, network 245 may include a cellular network (e.g., a 5G network, an LTE network, a 3G network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, and/or a combination of these or other types of networks.

The number and arrangement of devices and networks shown in FIG. 2A are provided as an example. In practice, there may be additional devices and/or networks, fewer devices and/or networks, different devices and/or networks, or differently arranged devices and/or networks than those shown in FIG. 2A. Furthermore, two or more devices shown in FIG. 2A may be implemented within a single device, or a single device shown in FIG. 2A may be implemented as multiple, distributed devices. Additionally, or alternatively, a set of devices (e.g., one or more devices) of environment 200A may perform one or more functions described as being performed by another set of devices of environment 200A.

FIG. 2B is a diagram of an example environment 200B in which systems and/or methods described herein may be implemented. As shown in FIG. 2B, example environment 200B may include a UE 102, a base station 210, a core network 201, and a data network 202. Devices and/or networks of example environment 200B may interconnect via wired connections, wireless connections, or a combination of wired and wireless connections.

UE 102 includes one or more devices capable of receiving, generating, storing, processing, and/or providing information, such as information described herein. For example, UE 102 can include a mobile phone (e.g., a smart phone or a radiotelephone), a laptop computer, a tablet computer, a desktop computer, a handheld computer, a gaming device, a wearable communication device (e.g., a smart watch or a pair of smart glasses), a mobile hotspot device, a fixed wireless access device, customer premises equipment, an autonomous vehicle, or a similar type of device.

Base station 210 includes one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for UE 102. Base station 210 may be included in a RAN may transfer traffic between UE 102 (e.g., using a cellular RAT), one or more base stations (e.g., using a wireless interface or a backhaul interface, such as a wired backhaul interface), and/or core network 202. RAN may provide one or more cells that cover geographic areas.

In some implementations, the RAN may perform scheduling and/or resource management for UE 102 covered by the RAN (e.g., UE 102 covered by a cell provided by the RAN). In some implementations, the RAN may be controlled or coordinated by a network controller, which may perform load balancing, network-level configuration, and/or other operations. The network controller may communicate with the RAN via a wireless or wireline backhaul. In some implementations, the RAN may include a network controller, a self-organizing network (SON) module or component, or a similar module or component. In other words, the RAN may perform network control, scheduling, and/or network management functions (e.g., for uplink, downlink, and/or sidelink communications of UE 102 covered by the RAN).

In some implementations, core network 201 may include an example functional architecture in which systems and/or methods described herein may be implemented. For example, core network 201 may include an example architecture of a 5G next generation (NG) core network included in a 5G wireless telecommunications system. While the example architecture of core network 201 shown in FIG. 2B may be an example of a service-based architecture, in some implementations, core network 201 may be implemented as a reference-point architecture and/or a 4G core network, among other examples.

As shown in FIG. 2B, core network 201 may include a number of functional elements. The functional elements may include, for example, the AMF device 108, the PCF device 110, a network slice selection function (NSSF) 250, a network exposure function (NEF) 255, an authentication server function (AUSF) 260, a unified data management (UDM) component 265, an application function (AF) 270, a session management function (SMF) 275, and/or a user plane function (UPF) 280. These functional elements may be communicatively connected via a message bus 285. Each of the functional elements shown in FIG. 2B is implemented on one or more devices associated with a wireless telecommunications system. In some implementations, one or more of the functional elements may be implemented on physical devices, such as an access point, a base station, and/or a gateway. In some implementations, one or more of the functional elements may be implemented on a computing device of a cloud computing environment.

AMF device 106 includes one or more devices that act as a termination point for NAS signaling and/or mobility management, among other examples.

PCF device 110 includes one or more devices that provide a policy framework that incorporates network slicing, roaming, packet processing, and/or mobility management, among other examples.

NSSF 250 includes one or more devices that select network slice instances for UE 102. By providing network slicing, NSSF 250 allows an operator to deploy multiple substantially independent end-to-end networks potentially with the same infrastructure. In some implementations, each slice may be customized for different services.

NEF 255 includes one or more devices that support exposure of capabilities and/or events in the wireless telecommunications system to help other entities in the wireless telecommunications system discover network services.

AUSF 260 includes one or more devices that act as an authentication server and support the process of authenticating UE 102 in the wireless telecommunications system.

UDM 265 UDM includes one or more devices that store user data and profiles in the wireless telecommunications system. UDM 265 may be used for fixed access and/or mobile access in core network 201.

AF 270 includes one or more devices that support application influence on traffic routing, access to NEF 255, and/or policy control, among other examples.

SMF 275 includes one or more devices that support the establishment, modification, and release of communication sessions in the wireless telecommunications system. For example, SMF 275 may configure traffic steering policies at UPF 280 and/or may enforce user equipment IP address allocation and policies, among other examples.

UPF 280 includes one or more devices that serve as an anchor point for intra-RAT and/or inter-RAT mobility. UPF 280 may apply rules to packets, such as rules pertaining to packet routing, traffic reporting, and/or handling user plane QoS, among other examples.

Message bus 285 represents a communication structure for communication among the functional elements. In other words, message bus 280 may permit communication between two or more functional elements.

Data network 202 includes one or more wired and/or wireless data networks. For example, data network 202 may include an IMS, a PLMN, a LAN, a WAN, a MAN, a private network such as a corporate intranet, an ad hoc network, the Internet, a fiber optic-based network, a cloud computing network, a third party services network, an operator services network, and/or a combination of these or other types of networks.

The number and arrangement of devices and networks shown in FIG. 2B are provided as an example. In practice, there may be additional devices and/or networks, fewer devices and/or networks, different devices and/or networks, or differently arranged devices and/or networks than those shown in FIG. 2B. Furthermore, two or more devices shown in FIG. 2B may be implemented within a single device, or a single device shown in FIG. 2B may be implemented as multiple, distributed devices. Additionally, or alternatively, a set of devices (e.g., one or more devices) of example environment 200B may perform one or more functions described as being performed by another set of devices of example environment 200B.

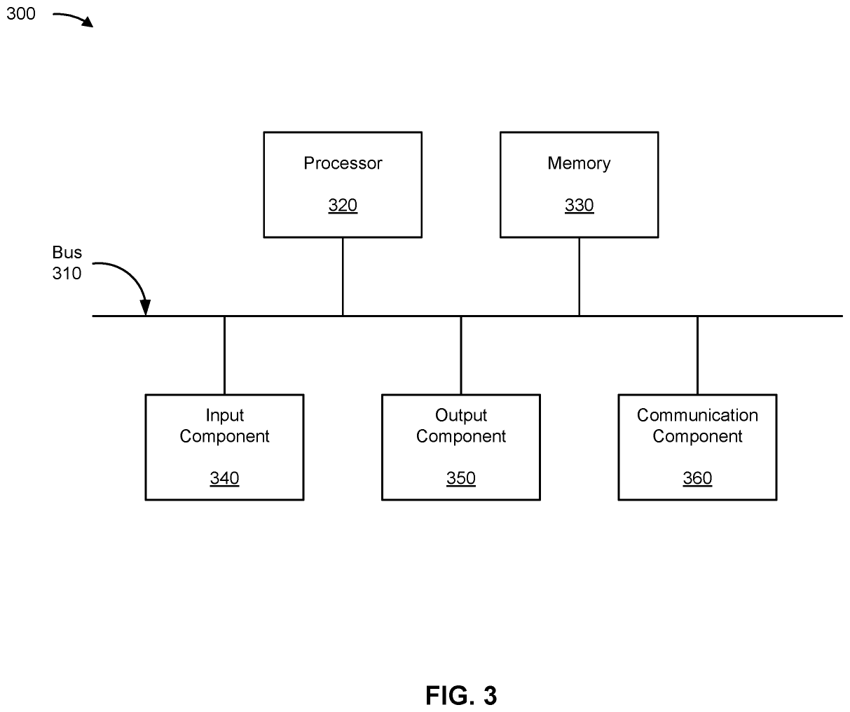

FIG. 3 is a diagram of example components of a device 300 associated with enhanced policy propagation. The device 300 may correspond to the UE 102, the base station 104, the MME device 106, the AMF device 108, the PCF device 110, the SGW 220, the PGW 225, the PCRF 230, the HSS 235, the AAA 240, the NSSF 250, the NEF 255, the AUSF 260, the UDM 265, the AF 270, the SMF 275, and/or the UPF 280. In some implementations, the UE 102, the base station 104, the MME device 106, the AMF device 108, the PCF device 110, the SGW 220, the PGW 225, the PCRF 230, the HSS 235, the AAA 240, the NSSF 250, the NEF 255, the AUSF 260, the UDM 265, the AF 270, the SMF 275, and/or the UPF 280 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

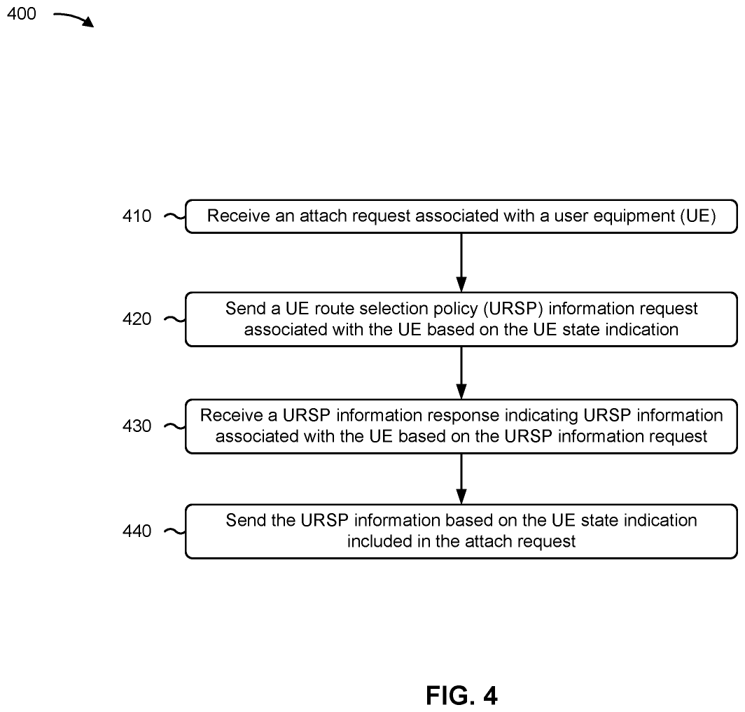

FIG. 4 is a flowchart of an example process 400 associated with enhanced policy propagation. In some implementations, one or more process blocks of FIG. 4 may be performed by an MME device (e.g., MME device 106). In some implementations, one or more process blocks of FIG. 4 may be performed by another device or a group of devices separate from or including the MME device, such as a UE (e.g., the UE 102), a base station (e.g., the base station 104), an AMF device (e.g., the AMF device 108), a PCF device (e.g., the PCF device 110), an SGW (e.g., the SGW 220), a PGW (e.g., the PGW 225), a PCRF (e.g., the PCRF 230), an HSS (e.g., the HSS 235), an AAA (e.g., the AAA 240), an NSSF (e.g., the NSSF 250), an NEF (e.g., the NEF 255), an AUSF (e.g., the AUSF 260), a UDM 265 (e.g., the UDM 265), an AF (e.g., the AF 270), an SMF (e.g., the SMF 275), and/or a UPF (e.g., the UPF 280). Additionally, or alternatively, one or more process blocks of FIG. 4 may be performed by one or more components of device 300, such as processor 320, memory 330, input component 340, output component 350, and/or communication component 360.

As shown in FIG. 4, process 400 may include receiving an attach request associated with a UE (block 410). For example, the MME device may receive an attach request associated with a UE, as described above. In some implementations, the attach request includes a UE state indication associated with the UE. The UE state indication may include existing URSP information associated with the UE.

As further shown in FIG. 4, process 400 may include sending, to an AMF device, a URSP information request associated with the UE based on the UE state indication (block 420). For example, the MME device may send, to an AMF device, a URSP information request associated with the UE based on the UE state indication, as described above. As an example, process 400 may include selecting the AMF device based on a distance between a location of the MME device and a location of the AMF device. As another example, process 400 may include selecting the AMF device based on a globally unique temporary identifier of the UE.

As further shown in FIG. 4, process 400 may include receiving, from the AMF device, a URSP information response indicating URSP information associated with the UE based on the URSP information request (block 430). For example, the MME device may receive, from the AMF device, a URSP information response indicating URSP information associated with the UE based on the URSP information request, as described above.

As further shown in FIG. 4, process 400 may include sending, for the UE, the URSP information based on the UE state indication included in the attach request (block 440). For example, the MME device may send, for the UE, the URSP information based on the UE state indication included in the attach request, as described above. In some implementations, process 400 includes receiving, from the UE, a manage UE policy complete message.

In some implementations, the URSP information may be associated with an application executing on the UE device and/or the URSP information may be associated with subscriber profile information associated with the UE.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel.

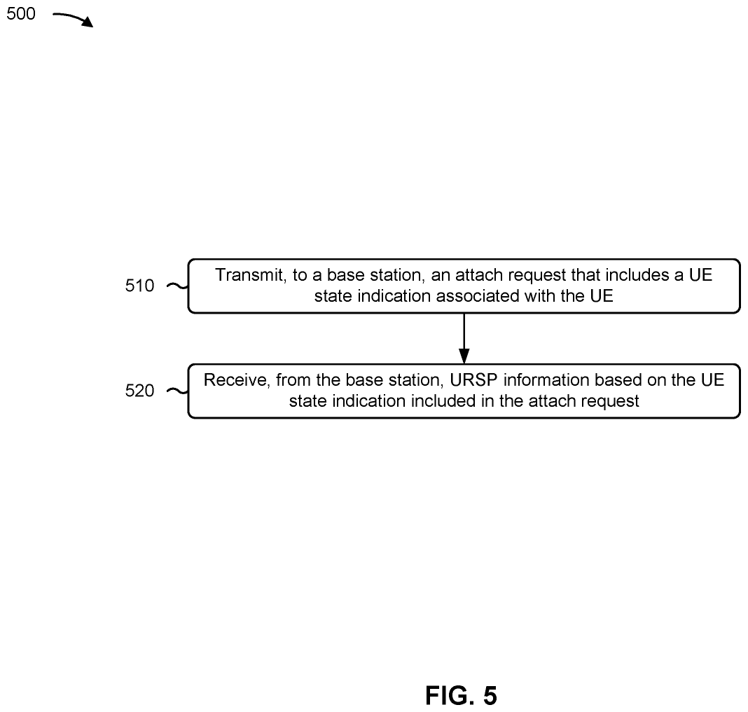

FIG. 5 is a flowchart of an example process 500 associated with enhanced policy propagation. In some implementations, one or more process blocks of FIG. 5 may be performed by a UE (e.g., UE 102). In some implementations, one or more process blocks of FIG. 5 may be performed by another device or a group of devices separate from or including the UE, such as a base station (e.g., the base station 104), an MME device (e.g., the MME device 106) an AMF device (e.g., the AMF device 108), a PCF device (e.g., the PCF device 110), an SGW (e.g., the SGW 220), a PGW (e.g., the PGW 225), a PCRF (e.g., the PCRF 230), an HSS (e.g., the HSS 235), an AAA (e.g., the AAA 240), an NSSF (e.g., the NSSF 250), an NEF (e.g., the NEF 255), an AUSF (e.g., the AUSF 260), a UDM 265 (e.g., the UDM 265), an AF (e.g., the AF 270), an SMF (e.g., the SMF 275), and/or a UPF (e.g., the UPF 280). Additionally, or alternatively, one or more process blocks of FIG. 5 may be performed by one or more components of device 300, such as processor 320, memory 330, input component 340, output component 350, and/or communication component 360.

As shown in FIG. 5, process 500 may include transmitting, to a base station, an attach request that includes a UE state indication associated with the UE (block 510). For example, the UE may transmit, to a base station, an attach request that includes a UE state indication associated with the UE, wherein the UE state indication indicates that the UE supports a UE route selection policy (URSP), as described above. In some implementations, the UE state indication indicates that the UE supports a UE route selection policy (URSP), a globally unique temporary identifier (GUTI) of the UE, and/or existing URSP information associated with the UE, among other examples. In some implementations, the UE state indication triggers retrieval of the URSP information. In some implementations, the URSP information may be associated with a subscriber profile related to the UE.

As further shown in FIG. 5, process 500 may include receiving, from the base station, URSP information based on the UE state indication included in the attach request (block 520). For example, the UE may receive, from the base station, URSP information based on the UE state indication included in the attach request, as described above. In some implementations, process 500 may include transmitting, to the base station, a UE policy complete message to acknowledge reception of the URSP information.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.”

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a mobility management entity (MME) device, an attach request associated with a user equipment (UE),
wherein the attach request includes a UE state indication associated with the UE;
sending, by the MME and to an access and mobility function (AMF) device, a UE route selection policy (URSP) information request associated with the UE based on the UE state indication;
receiving, by the MME and from the AMF device, a URSP information response indicating URSP information associated with the UE based on the URSP information request; and
sending, by the MME and for the UE, the URSP information based on the UE state indication included in the attach request.

2. The method of claim 1, further comprising:
receiving a manage UE policy complete message.

3. The method of claim 1, further comprising:
selecting the AMF device based on a distance between a location of the MME device and a location of the AMF device.

4. The method of claim 1, further comprising:
selecting the AMF device based on a globally unique temporary identifier of the UE.

5. The method of claim 1, wherein the URSP information is associated with an application executing on the UE device.

6. The method of claim 1, wherein the URSP information is associated with subscriber profile information associated with the UE.

7. The method of claim 1, wherein the UE state indication includes existing URSP information associated with the UE.

8. A user equipment (UE), comprising:
one or more processors configured to:
transmit, to a base station, an attach request that includes a UE state indication associated with the UE,
wherein the UE state indication indicates that the UE supports a UE route selection policy (URSP); and
receive, from the base station, URSP information based on the UE state indication included in the attach request.

9. The UE of claim 8, wherein the one or more processors are further configured to:
transmit, to the base station, a UE policy complete message to acknowledge reception of the URSP information.

10. The UE of claim 8, wherein the UE state indication triggers retrieval of the URSP information.

11. The UE of claim 8, wherein the UE state indication message indicates a globally unique temporary identifier (GUTI) of the UE.

12. The UE of claim 8, wherein the UE state indication message indicates existing URSP information associated with the UE.

13. The UE of claim 8, wherein the URSP information is associated with a subscriber profile related to the UE.

14. A non-transitory computer-readable medium storing a set of instructions, the set of instructions comprising:
one or more instructions that, when executed by one or more processors of a mobility management entity (MME) device, cause the MME device to:
receive an attach request associated with a user equipment (UE),
wherein the attach request includes a UE state indication associated with the UE;
send, to an access and mobility function (AMF) device, a UE route selection policy (URSP) information request associated with the UE based on the UE state indication;
receive, from the AMF device, a URSP information response indicating URSP information associated with the UE based on the URSP information request; and
send, for the UE, the URSP information based on the UE state indication included in the attach request.

15. The non-transitory computer-readable medium of claim 14, wherein the one or more instructions, when executed by the one or more processors of the MME device, further cause the MME device to:
receive, from the UE, a manage UE policy complete message.

16. The non-transitory computer-readable medium of claim 14, wherein the one or more instructions, when executed by the one or more processors of the MME device, further cause the MME device to:
select the AMF device based on a distance between a location of the MME device and a location of the AMF device.

17. The non-transitory computer-readable medium of claim 14, wherein the one or more instructions, when executed by the one or more processors of the MME device, further cause the MME device to:
select the 5G network device based on a globally unique temporary identifier of the UE.

18. The non-transitory computer-readable medium of claim 14, wherein the URSP information is associated with an application executing on the UE device.

19. The non-transitory computer-readable medium of claim 14, wherein the URSP information is associated with subscriber profile information associated with the UE.

20. The non-transitory computer-readable medium of claim 14, wherein the UE state indication includes existing URSP information associated with the UE.
